(19) United States
(12) Patent Application Publication
(10) Pub. No.: US 2009/0180166 A1
(43) Pub. Date: Jul. 16, 2009

(54) Imaging using diffraction optics elements

(75) Inventors: Yaniv Hefetz, Givataim (IL); Noam Sorek, Zikhron-Yaakov (IL); Sharon Sade, Kfar-Yona (IL)

Correspondence Address: MARTIN D. MOYNIHAN d/b/a PRTSI, INC., P.O. BOX 16446, ARLINGTON, VA, 22215, US

(73) Assignee: Samsung Electronics Co., Ltd., Gyeonggi-do (KR)

(21) Appl. No.: 12/007,879

(22) Filed: Jan. 16, 2008

(51) Int. Cl. G02B 5/32; G02B 5/18

(52) U.S. Cl. 359/16; 359/566

(57) ABSTRACT

An apparatus for manipulating a perceived distance of a display. The apparatus comprises a display having an actual distance from a point of view (POV) and a diffractive optics element for diffracting light waves emitted from the display toward the POV, thereby manipulating a perceived distance of the display for an observer at the POV. The perceived distance is different from the actual distance.

### FIELD AND BACKGROUND OF THE INVENTION

The present invention relates to a method and an apparatus for creating a virtual image and, more particularly, but not exclusively, to a method and an apparatus for creating virtual image of a light source or an illuminated area on a certain point of view (POV).

Individuals and corporations need information to function and do business in information driven society. Increasingly, individuals and corporations are expressing a preference for receiving information in real time through portable electronic devices. Examples of portable electronic devices used to receive real time information include cellular telephones, pagers, personal digital assistants, geographical positioning systems, and palm size computers. Generally, these portable electronic devices have a small information display area. For example, a personal digital assistant typically has a flat panel display having an information display area of six or seven square centimeters. A mobile device typically has a liquid crystal display (LCD) for displaying telephone numbers, instructions and other information useful for the user to view during operation of the telephone. The LCD is protected by a display window that has a transparent portion so that the items displayed on the LCD can be easily viewed by the user.

Some unique information display areas are known. For example, U.S. Patent Application No. 2007/0092689, published on Apr. 26, 2007, describes a method of fabricating a flexible display. The method comprising selecting a first flexible sheet and a second flexible sheet; and forming a number of magnetic display elements having magnetically controllable reflectivity between the first flexible sheet and the second flexible sheet. In some embodiments, a display includes pixels having a magnetically controllable reflectivity. The pixels are formed between a pair of flexible non-conductive sheets. Each of the magnetically controllable pixels includes a flexible ring located between the flexible non-conductive sheets. Each of the magnetically controllable pixels also includes magnetic particles located within the flexible ring. The location of the magnetic particles with respect to the flexible non-conductive sheets determines the reflectivity of the pixel. The display is especially suitable for use in connection with portable electronic devices.

The Talbot effect is a near field diffraction effect that has been observed both with light and with atom optics. When a plane wave is transmitted through a grating or other periodic structure, the resulting wave front propagates in such a way that it replicates the structure at multiples of a certain defined distance, known as the Talbot length. The Talbot effect for matter waves has been studied in the last decades. One scientific paper which is related to the Talbot effect is Bernd Rohwedder, “Atom Optical Elements Based on Near-field Grating Sequences,” Fortschr. Phys. 47 9-10, 883-911 (1999), which is incorporated herein by reference. The paper focuses on matter-wave diffraction due to near-field grating sequences contains in-depth and extensive Fourier optics approaches to describing these atom-optical situations.

Works that are more recent describe applications that make use of the Talbot effect. For example, Jose Lunazzi, White-Light Imaging in a Two Gratings Diffraction Process, Laboratório de Óptica, DFMC, Instituto de Fisica Gleb Wataghin Universidade Estadual de Campinas 13083-970-Campinas, S P, Brasil, which is incorporated herein by reference, describes white light imaging by double diffraction using linear gratings and a pine-hole or vertical slit as wavelength bandwidth. The white light imaging application, which is described in this paper, provides imaging in relatively low resolution and in relatively low diffractive efficiency. Moreover, the white light imaging application that is described in the paper has chromatic and geometrical aberrations. Furthermore, the paper describes an imaging device with two gratings that is effective when the distance between the two gratings is more than 500 mm.

### SUMMARY OF THE INVENTION

According to one aspect of the present invention there is provided an apparatus for manipulating a perceived distance of a display. The apparatus comprises a display having an actual distance from a point of view (POV), and a diffractive optics element configured for diffracting a plurality of light waves emitted from the display toward the POV, thereby manipulating a perceived distance of the display for an observer at the POV. The perceived distance is different from the actual distance.

Optionally, the display is a source of white light.

Optionally, the display is a flat panel display.

Optionally, the apparatus further comprises a correction element configured for correcting optical aberrations of the display.

More optionally, the correction element comprises a monochromatic kinoform for correcting monochromatic aberrations of the display.

Optionally, the diffractive optics element comprises a graded grating configured for diffracting the plurality of light waves toward the POV.

Optionally, the diffractive optics element is configured for diffracting a plurality of light waves while maintaining more than 80% diffraction efficiency.

Optionally, the display comprises a user interface display.

Optionally, the diffractive optics element is configured for converging light waves of the plurality of light waves onto an optical coincidence at the POV.

Optionally, the display is perceived in focus by the observer at the POV.

More optionally, the diffractive optics element comprises at least first and second diffractive optics elements, the first diffractive optics element being configured for diffracting light onto the second diffractive optics element, the second diffractive optics element being configured for performing the converging.

More optionally, each the first and second diffractive optics elements respectively comprising first and second curved gratings, the first and second curved gratings being configured to diffract the plurality of light waves toward substantially opposite directions.

More optionally, the first and second diffractive optics elements respectively have first and second diffraction orders, the first diffraction order being higher than the second diffractive order.

Optionally, the perceived distance is longer than from than the actual distance.

Optionally, the perceived distance is shorter than the actual distance.

Optionally, the diffractive optics element comprising a member of the group consisting of: holographic transmission gratings with linear grooves, holographic transmission gratings with circular grooves, blazed gratings, kinoform gratings, and sinusoidal gratings.

Optionally, the display comprises a conversation module for converting an original image to an adjusted image according to optical aberration of the diffractive optics element, the display being configured for presenting the adjusted image.

More optionally, the optical aberration comprises a member of a group comprising a monochromatic aberration and a chromatic aberration.

More optionally, the original image depicts a user interface display.

According to one aspect of the present invention there is provided a handheld device for displaying a user interface. The handheld device comprises a display having an actual distance from a point of view (POV) and an embedded light manipulation element, positioned substantially in front of the display, configured for manipulating a perceived distance of the display from an observer at the POV. The perceived distance is different from the actual distance.

Optionally, the light manipulation element comprises a diffractive optics element configured for manipulating the perceived distance by diffracting an image of the display toward the POV.

Optionally, the handheld further comprises a user interface module configured for displaying a user interface on the display embedded light manipulation being configured for manipulating a perceived distance of the user interface from an observer at the POV.

Optionally, the handheld device is a cellular phone.

Optionally, the thickness of the embedded light manipulation element is less than 3 mm.

According to one aspect of the present invention there is provided a method for manipulating a perceived distance of a display. The method comprises receiving a plurality of light rays from a display having an actual distance from a point of view (POV) and diffracting the plurality of light rays toward the POV. In such an embodiment, for an observer at the POV, a perceived distance of the display is manipulated by the diffraction, the perceived distance being different from the actual distance.

Optionally, the diffracting comprises focusing an image of the display at the POV.

Optionally, the diffracting comprises converging the plurality of light waves onto an optical coincidence at the POV.

Optionally, the diffracting comprises expecting the trajectory of the plurality of light waves.

Optionally, the method comprises displaying a user interface on the display before the receiving, the plurality of light waves being emitted from the displayed user interface.

Optionally, for the observer the display is perceived as more distant than the actual distance.

Optionally, for the observer the display is perceived as less distant than the actual distance.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and apparatus of the present invention involves performing or completing certain selected tasks or steps manually, automatically, or a combination thereof. Moreover, according to actual instrumentation and equipment of preferred embodiments of the method and apparatus of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and apparatus of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a schematic illustration of an imaging device for diffracting light emitted from a light source, such as a white light display, toward a point of view in which the perceived distance to the light source is different from the actual distance thereto, according tone embodiment of the present invention;

FIG. 2 is a schematic illustration of the imaging device of FIG. 1 in which the diffractive optics element includes two diffractive optics sub-elements, according to one embodiment of the present invention;

FIG. 3 is a schematic color illustration of a display, such as an LCD display, and a diffractive optics element, according to one embodiment of the present invention;

FIG. 4 is a schematic color illustration of a magnification of the display and the diffractive optics element, which are depicted in FIG. 3, according to one embodiment of the present invention;

FIG. 5 is a schematic color illustration of the convergence of light at the point of view of the user, according to one embodiment of the present invention;

FIG. 6 is an output of the Zemax software that includes a spot diagram of a display, according to one embodiment of the present invention;

FIG. 7 is an output of the Zemax software that is based on the spot diagram of FIG. 6, according to one embodiment of the present invention;

FIG. 8 is a schematic illustration of the imaging device of FIG. 2 and two virtual observers;

FIG. 9 is a schematic illustration of three sequential segments of a unique profile of the grating grooves, according to one embodiment of the present invention;

FIG. 10 is a schematic illustration of three segments of another profile of a grating, according to an exemplary embodiment of the present invention;

FIG. 11 is a table depicting the diffraction efficiency of light that impedes the grating in different angles, according to an embodiment of the present invention;

FIG. 12 is a schematic illustration of a kinoform that is designed to be integrated into a grating, according to an embodiment of the present invention;

FIG. 13 is a schematic illustration of a segment of a grating that comprises three grooves and three kinoforms, according to an embodiment of the present invention;

FIG. 14 is a schematic illustration of an imaging device having two diffractive optics sub-elements with curved grating, according to a preferred embodiment of the present invention; and

FIG. 15 is a flowchart of a method for manipulating a perceived distance of a light source, according to one embodiment of the present invention.

### DESCRIPTION OF THE PREFERRED EMBODIMENTS

Some of the present embodiments comprise a device, such as a cellular phone a cellular phone or a personal digital assistant (PDA) and a method for manipulating a perceived distance of a light source. The device comprises a display, optionally of a white light, having an actual distance from a point of view (POV) and a diffractive optics element (DOE) that is designed for diffracting light emitted from the display toward the POV. The diffraction of light manipulates the perceived distance of the light source for an observer at the POV, optionally as described below. The perceived distance is different from the actual distance.

The aforementioned device may be used by observers that suffer from Hyperopia for focusing on nearby objects.

Some of the present embodiments comprise mobile communication device, such as a cellular phone, for displaying a user interface in a different distance from the actual distance thereof. Such a mobile communication device comprises a display having an actual distance from a point of view (POV), a light manipulation element, such as a DOE, which can be used for manipulating a perceived distance of the display from an observer at the POV. Optionally, the light manipulation element diffracts the light emitted from the display in a manner an observer at the POV perceives the distance of the display as more or less distant than it really is.

The principles and operation of an apparatus and method according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. In addition, it is to be understood that the phraseology and terminology employed herein is for the purpose of description and should not be regarded as limiting.

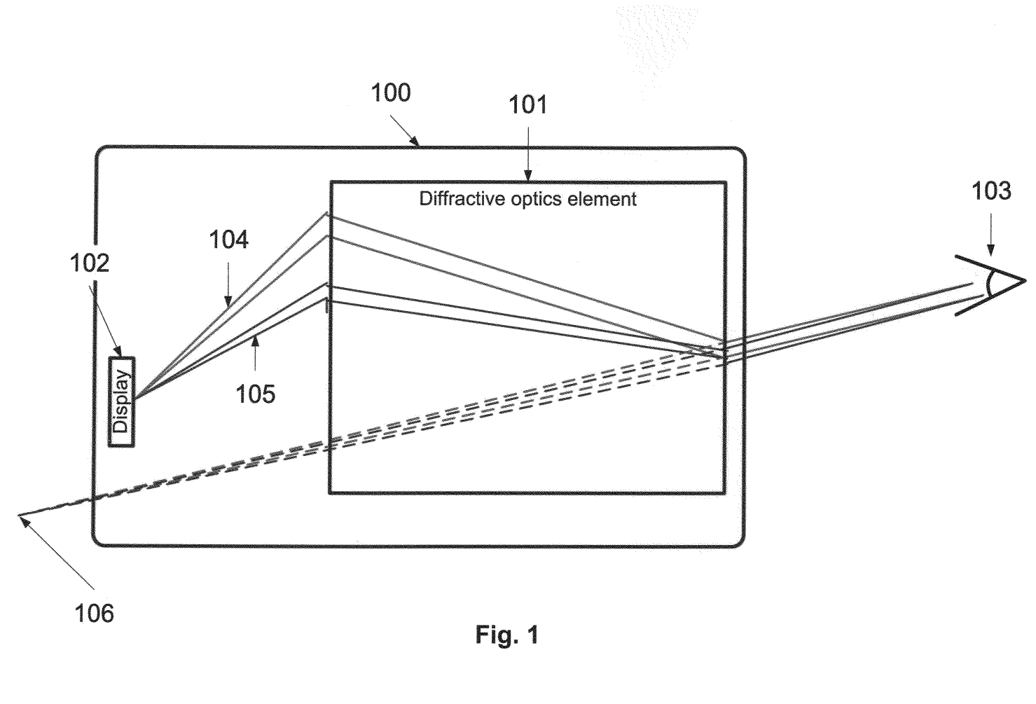

Reference is now made to FIG. 1, which is a schematic illustration of an imaging device 100 for diffracting the light emitted from a display 102, such as a white light display, for example Cathode Ray Tube CRT, liquid crystal display LCD and thin film electroluminescent (TFEL), according to one embodiment of the present invention. The imaging device 100 diffracts the light emitted from the display 102 toward a point of view (POV), which may be referred to as an imaging device POV 103. The diffraction manipulates the light in a manner that the perceived distance from the imaging device POV 103 to the display 102 is different from the actual distance between the imaging device POV 1 03and the display 102. For example, the diffraction manipulates the light in a manner that the perceived distance from the imaging device POV 103 is to virtual perception point 106.

The imaging device 100 optionally includes the display 102, optionally a source of white light, such as a white light display, and a diffractive optics element (DOE) 101 for diffracting light emitted from the display 102 toward the imaging device POV 103. Optionally, as described below, the DOE 101 diffracts the light emitted from the display 102 in a manner that the perceived distance of the light source for an observer that is positioned at the imaging device POV.

Optionally, the DOE 101 diffracts the light emitted from the display 102 in a manner that the observer at the imaging device POV 103 perceives the distance of the display 102 as more distant or as less distant than it really is. The DOE 101, which is optionally placed in front of the display 102, diffracts the light waves which are coming therethrough by taking advantage of the diffraction phenomenon. In particular, the DOE 101 is a substrate or an array of substrates on which complex microstructures, which may be referred to as grooves, are created to modulate and to transform impinging light waves through diffraction. The DOE 101 controls the diffraction of the impinging light waves by modifying their wavefronts by interference and/or phase control. As the impinging light waves pass through the DOE 101, their phase and/or their amplitude may be changed according to the arrangement of the complex microstructures. The DOE 101 may comprise one or more holographic transmission gratings with linear grooves, holographic transmission gratings with circular grooves, blazed gratings, multilevel phase relief DOE, kinoform structure gratings, and sinusoidal gratings.

It should be noted that the DOE 101 diffracts light waves which are centered on a certain wavelength, as shown at 104, different from light waves which are centered on a another wavelength, as shown at 105.

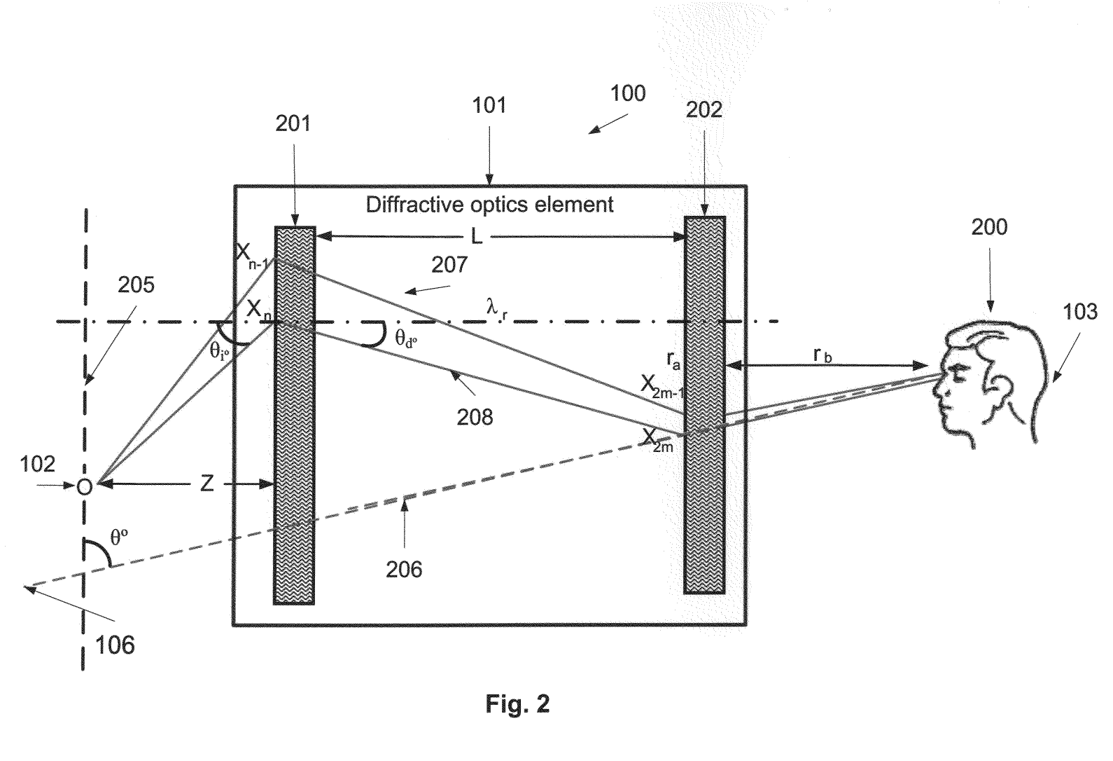

Reference is now made to FIG. 2, which is a schematic illustration of the imaging device 100 of FIG. 1, according to one embodiment of the present invention. The display 102 is as depicted in FIG. 1, however in FIG. 2, an observer 200 is positioned in the imaging device POV 103 and the DOE 101 includes two diffractive optics sub-elements 201, 202, according to some embodiments of the present invention. FIG. 2 depicts two exemplary trajectories 207, 208 of two light waves, which are emitted from the display 102 and diffracted toward the imaging device POV 103 by the DOE 101. FIG. 2 further depicts a virtual line of sight (LOS) 206 between the imaging device POV 103 of the observer and the origin of the two light waves 207, 208 which are the display 102.

The two diffractive optics sub-elements 201, 202 converge light emitted from the display 102 in a double diffraction process. In this embodiment, a set of luminous rays exiting from the display 102, which is optionally a two-dimensional (2D) and/or three-dimensional (3D) white-display 102, impinges the first diffractive optics sub-element 201, for example as shown at points Xₙ₋₁ Xₙ that denote the impinging points of light wave n and n-1 at the first diffractive optics sub-elements 201.

The first diffractive optics sub-element 201 diffracts the impinging light waves toward a point on the second diffractive optics sub-element 202. For example, the two exemplary trajectories 207, 208 of the two light waves are diffracted from points Xₙ₋₁ and Xₙ toward points x₂ₘ₋₁ and x₂ₘ on the second diffractive optics sub-element 202.

As shown at 207 and 208, the second diffractive optics sub-element 202 converges the impinging rays onto an optical coincidence at the imaging device POV 103. The converged impinging rays are diffracted toward the imaging device POV 103, optionally to impinge the cornea of the observer 200. Optionally, the DOE 101 converges incident light waves, which are emitted from the display 102, as a lens that is defined with an aperture that launches a perspective of an image plane to be collected substantially precisely onto the optical coincidence at the imaging device POV 103 when a focusing condition is achieved. Briefly stated, the convergence of the light waves allows the observer 200 to perceive an image that depicts the display 102 in a distance that is greater than the actual distance between the observer 200 at the imaging device POV 103 and the display 102. Optionally, the second diffractive optics sub-element 202 diffracts the impinging rays are converged in an acute angle in relation to the axis 205 of the display 102, allowing the observer 103 to receive a perceived image when he looks approximately toward an acute angle of θ°, for example as shown at 206.

Such an embodiment may be used for changing the perceived distance of a display, such as a white light display for people how suffer from Hyperopia, which is also known as hypermetropia or colloquially as farsightedness or longsightedness. Hyperopia, which is a defect of vision caused by an imperfection in the eye, often when the eyeball is too short or when the lens cannot become round enough, causes the inability to focus on near objects. In Hyperopia, the power of the cornea and lens is insufficient to keep an image of objects that move towards the eye on the retina and these objects may appear blurred. By using the imaging device 100, an observer that suffers from Hyperopia may perceive the display 102, which is optionally a display, such as a white light display of a cellular phone or a PDA, at a longer distant than it is really is. Such a perception allows the corneas and lenses of the observer's eyes to keep an image of display 102 in focus.

Reference is now made to an arithmetical presentation of the diffraction made by the first and second diffractive optics sub-elements 201, 202. The description of following section is provided with reference to a trajectory of a light wave that is emitted from the display 102, for example as shown at 208. It should be noted that though FIG. 2 depicts only one exemplary trajectory of one light wave, the display 102 emits a plurality of light waves which are manipulated in a similar manner.

The diffraction of an incident light wave, which is emitted from the display 102, by the first diffractive optics sub-element 201 may be described as follows according to the grating equation:

sin θᵢ+sin θ_{d}=2λN [1]

Where λ denotes the wavelength of the light wave, N denotes the grating frequency, θᵢ denotes an angle of incidence of the light wave with the first diffractive optics sub-element 201, and θ_{d} denotes the angle in which the first diffractive optics sub-element 201 diffracts the light wave, both in relation to a perpendicular to the first diffractive optics sub-element 201, for example as shown at 208. In FIG. 2 θᵢ and θ_{d} should be between the ray and the normal to the grating.

The diffraction of the light wave, which is defined in equation 1, may be described as follows:

$$\frac{{x}_{1 n}}{\sqrt{{x}_{1 n}^{2} + {Z}^{2}}} + \frac{{x}_{1 n} - {x}_{2 m}}{\sqrt{{( {x}_{1 n} - {x}_{2 m} )}^{2} + {L}^{2}}} = 2 {λ}_{n} N \qquad [ 2 ]$$

where Z denotes the distance between the display 102 and the first diffractive optics sub-element 201, L denotes the distance between the diffractive optics sub-elements 201, 202, as depicted in FIG. 2, and λₙ denotes the wavelength of ray xₙ.

At the atom level, the second diffractive optics sub-element 201 diffracts an incident light wave, which is received from the diffraction of a first diffractive optics sub-element 201. Optionally, second diffractive optics sub-element 201 is defined as follows:

$$\frac{{x}_{1 n} - {x}_{2 m}}{\sqrt{{( {x}_{1 n} - {x}_{2 m} )}^{2} + {L}^{2}}} + \frac{{r}_{a} - {x}_{2 m}}{\sqrt{{( {r}_{a} - {x}_{2 m} )}^{2} + {r}_{b}^{2}}} = {λ}_{n} N \qquad [ 3 ]$$

where rₐ denotes the coordinates of the second diffractive optics sub-element 202 and r_{b} denotes the coordinates of the observer 200 at the imaging device POV 103.

Equations 1-3 are written for the first and second orders However, in the second order, where the diffraction efficiency of more than 80% is unachievable under scalar approximation theory. As commonly known, according to scalar theory, the diffraction efficiency around the second order is zero for the phase level of DOEs and therefore only around the first order we can achieve high diffraction efficiencies. Thus, applying it to orders is feasible under scalar theory and manufacturing processing under specific groove densities.

In an exemplary embodiment of the present invention, the first diffractive optics sub-element 201 has a holographic grating with ˜1852 lines per millimeter and the holographic gratings of the second diffractive optics sub-element 202 has ˜1827 lines per millimeter. The second order diffraction of the first diffractive optics sub-element 201 and the first diffraction order of the second diffractive optics sub-element 202 correspond with equations 1-4 which are provided above. In the first diffractive optics sub-element 201, D equals to ˜5.4×10⁻⁴ mm and in the second diffractive optics sub-element 202, D equals to ˜5.47×10⁻⁴ mm. The effective area of each grating is ˜35 mm×45 mm, which is optionally the size of mobile display. The diffractive optics sub-elements 201, 202 are positioned in parallel to one another and the distance between them, which is denoted by L in FIG. 2, is 3 mm.

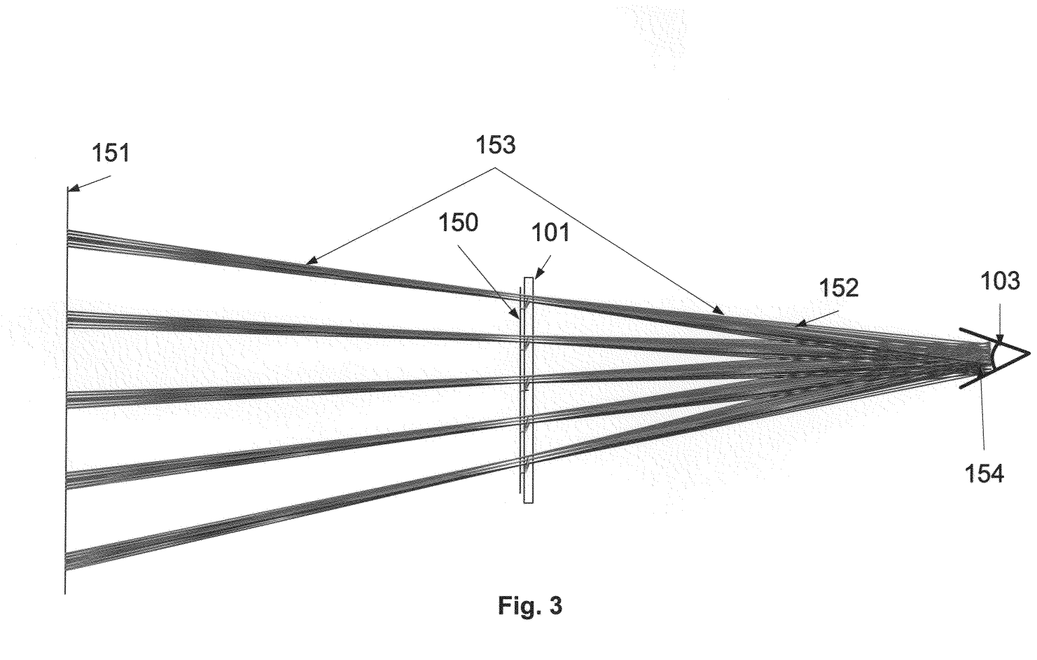

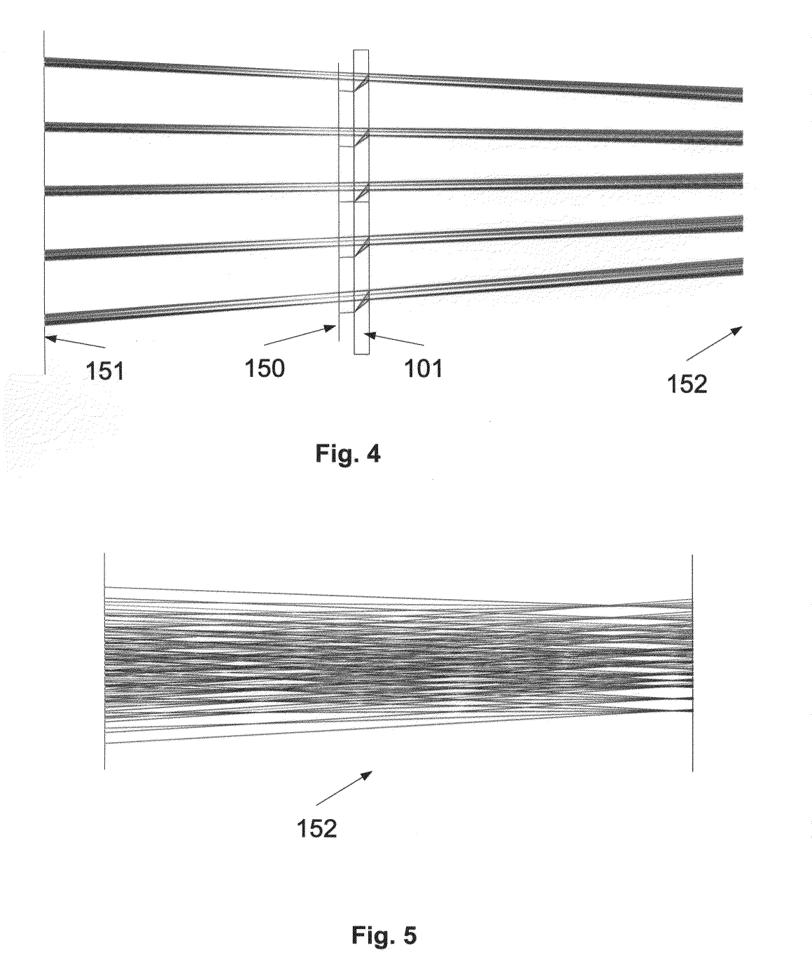

Reference is now made to FIG. 3, which is a schematic color illustration of a display 150 102, such as an LCD display, and a diffractive optics element, which is optionally as shown at 101 and to FIG. 4, which is a schematic color illustration of a magnification of the display 150 and the diffractive optics element 101 which are depicted in FIG. 3. Both FIGS. 3 and 4 depict embodiments of the present invention. FIG. 3 depicts the trajectories 152 of light rays emitted from the display 150 and diffracted toward the imaging device POV 103. FIG. 3 further depicts virtual trajectories 153 that simulate light emitted from a virtual display that is similar to the virtual display that the observer at the imaging device POV 103 sees as an outcome of the aforementioned diffraction. As shown at 154, red green and blue light is converged at the imaging device POV 103, allowing the observer to see a clear color image of the display 150 as if it is more distant than it is really is, for example as if it was at the virtual perception point that is shown at 106. The convergence of light is also shown at FIG. 5, which is a schematic color illustration of the convergence of light at the POV 103, according to an embodiment of the present invention. It should be noted that the image that is generated on the POV 103 has no lateral color or relatively low lateral color.

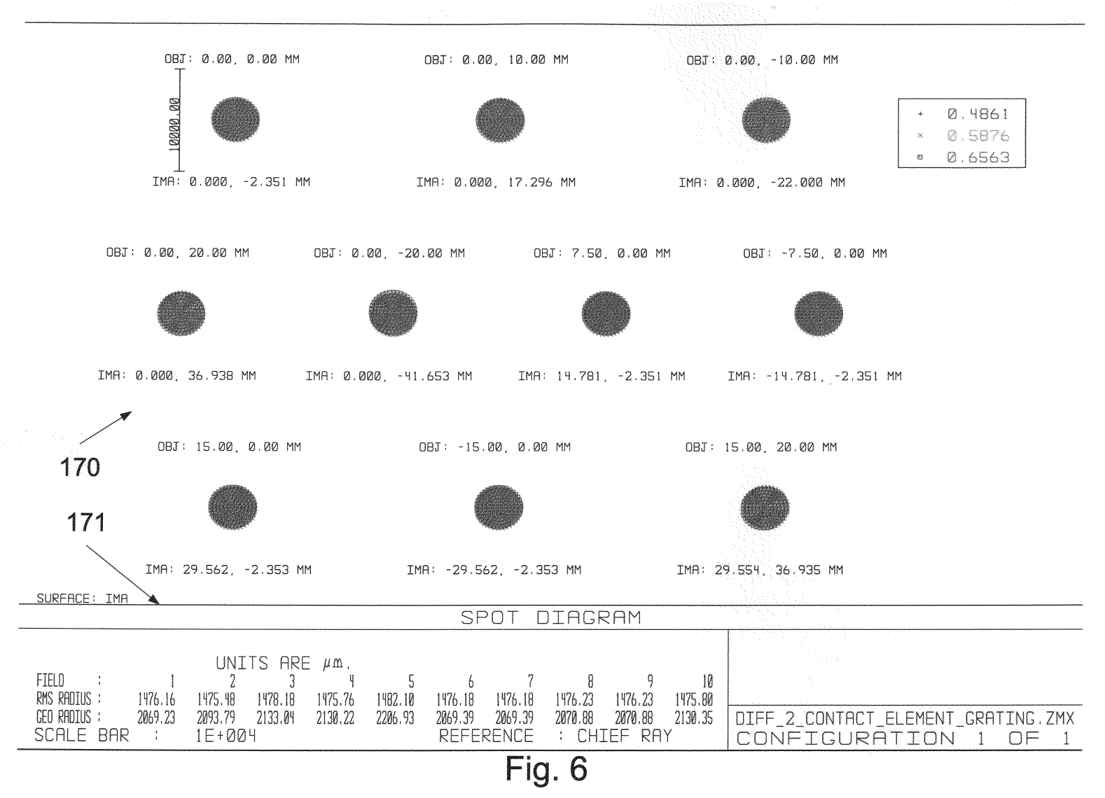

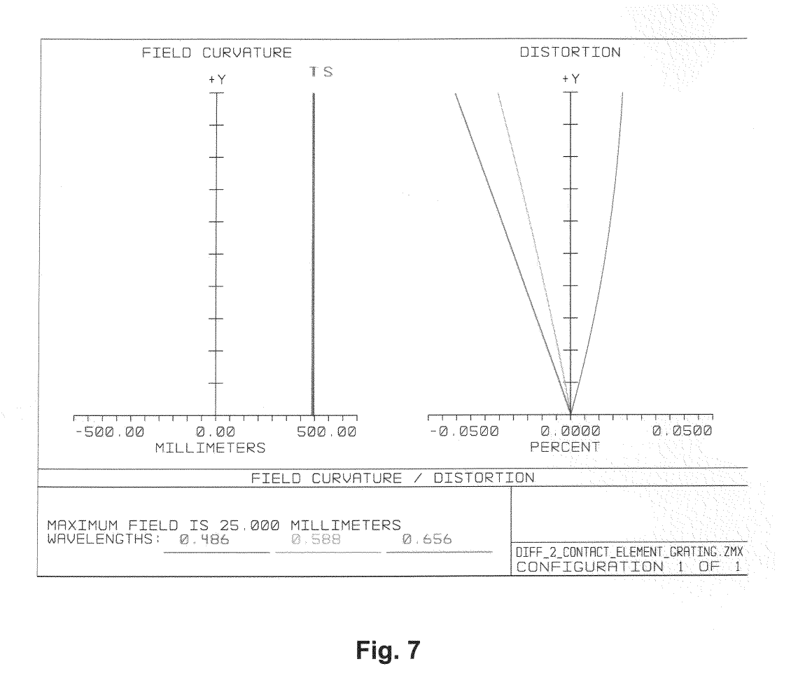

Reference is now also made to FIG. 6, which is an output of the Zemax™ software that includes a spot diagram that is based on the emissions of an exemplary display, such as 150, that emits ten different spots. The spot diagram illustrates the geometric image blur corresponding to a point object, such as a light spot on the display. The spot diagram can be used for examining the aberrations of the diffracted display. As shown at the spot diagram 170 and in the table 171 that summarizes the root mean square (RMS) radiuses the geometric (GEO) radiuses of each one of the spots the diffracted image of the display 150 has little or no lateral color. Furthermore, as shown at FIG. 7, which is an output of the Zemax software that is based on the spot diagram of FIG. 6, the color distortion is lower than 0.05%.

The second diffractive optics sub-element 202 diffracts the light waves, which already have been diffracted by the first diffractive optics sub-element 201, in an angle that is defined as follows:

$${ϕ}_{d , n} = arcsin ( \frac{{x}_{1 n}}{\sqrt{{x}_{1 n}^{2} + {Z}^{2}}} - {λ}_{n} N ) \qquad [ 4 ]$$

In addition, as shown in the following equation, there is a direct proportion between the distance from the first diffractive optics sub-element 201 to the virtual perception point 106 and the distance from the first diffractive optics sub-element 201 to the imaging device POV 103:

$${d}_{image} = \sqrt{\frac{( {y}_{1} + {z}_{1} ) ( {y}_{2} + {z}_{2} )}{tg {θ}_{1} \cdot tg {θ}_{2}}} - L \qquad [ 5 ]$$

where yₙ denotes a vertical inclined of the image point d_{image}, zₙ denotes a ray that impinges the second DOE, and θₙ denotes the angle, which, may be understood as the field of view angle, in which the observer may see an image according to the rays that impinge her eyes.

For clarify, equations [1]-[3] can be used to deduce the following expression:

$${d}_{image} = \sqrt{\frac{( {y}_{1} + {z}_{1} ) ( {y}_{2} + {z}_{2} )}{( \frac{{x}_{1} - {z}_{1}}{\sqrt{{( {x}_{1} - {z}_{1} )}^{2} + {L}^{2}}} - n λ {N}_{2} ) ( \frac{{x}_{2} - {z}_{2}}{\sqrt{{( {x}_{2} - {z}_{2} )}^{2} {L}^{2}}} - n λ {N}_{2} )}} - L \qquad [ 6 ]$$

where X₁ and X₂ may be calculated numerically and/or analytically by the following expression:

$$\begin{matrix}\frac{{x}_{1}}{{d}_{oblect}} = n λ {N}_{1} - \frac{{x}_{1} - {z}_{1}}{\sqrt{{x}_{1}^{2} - {z}_{1}^{2}} + {L}^{2}} ; and & [ 7 ] \\ \frac{{x}_{2}}{{d}_{oblect}} = n λ {N}_{1} - \frac{{x}_{2} - {z}_{2}}{\sqrt{{x}_{2}^{2} - {z}_{2}^{2}} + {L}^{2}} . & [ 8 ]\end{matrix}$$

However, a fine tuning process may be required for calibrating the imaging device 100 according to various frequencies and/or various distances between the diffractive optics sub-elements and the imaging device POV 103, the aforementioned direct proportion is kept.

Optionally, more the imaging device 100 comprises more than a pair of diffractive optics sub-elements. In such an embodiment, the LOS between the imaging device POV 103 and the display 102 may be extended as the trajectory of the light waves it emits may be longer.

Optionally, the diffractive optics sub-element 201, 202 are part of a single block with light incident surfaces. The single block may be a monoblock of transparent glass or layers of glass which are adhered to one another. Optionally, the diffractive optics sub-element 201, 202 are formed and/or adhered, optionally in parallel, at two facing lateral walls of a box-like monoblock.

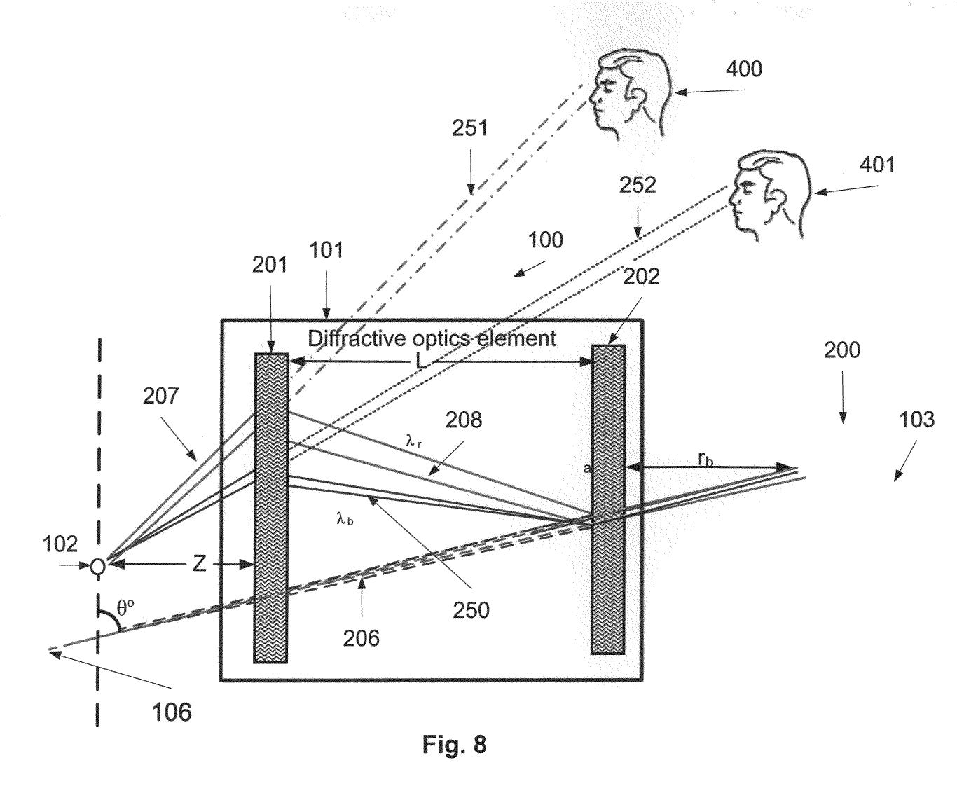

Reference is now made to FIG. 8, which is a schematic illustration of the imaging device 100 of FIG. 2, according to one embodiment of the present invention. The imaging device 100 is as depicted in FIG. 2, however FIG. 8, further depicts two virtual observers 400, 401 in two different POVs, and an additional pair of light waves 250, denoted by λ_{b}, which are centered on a different wavelength from the pair of light waves 207, 208, which is depicted in FIG. 2. FIG. 8 further depicts the LOSs 251, 252 between the observers 400, 401 and the light source.

As described above, the diffractive optics sub-elements 201, 202 diffract light waves centered on different wavelengths in different angles. As each light wave is diffracted differently, each one of the virtual observers 400, 401, which are positioned in different POVs, does not receive light waves, which are received by the other of the virtual observers 401, 400. However, the observer 200 can observe a convergence of the light waves at the optical coincidence of the light waves at the imaging device POV 103.

It should be noted that the LOSs 251, 252 of the virtual observers 400, 401 passes via the first diffractive optics sub-element 201 and not via the second diffractive optics sub-element 202. Thus, from their POVs, the first diffractive optics sub-element 201 functions as a prism with wavelength dependence inversion and therefore perceived distance of the display 102 is not changed. On the other hand, the LOS of the observer 200 passes through the first and the second diffractive optics sub-elements 201, 202. Thus, from the imaging device POV 103, the first and the second diffractive optics sub-elements 201, 202 functions as a lens with an aperture that is designed to launch incident light, which impinges its image plane, to be converged substantially precisely in an optical coincidence at the imaging device POV 103 when a focusing condition is achieved.

It should be noted that the images formed by the imaging device 100 have better focusing properties and are more chromatically correct than comparable images which are taken via a prism. Optionally, no intermediate element is positioned between the first and the second diffractive optics sub-elements 201, 202.

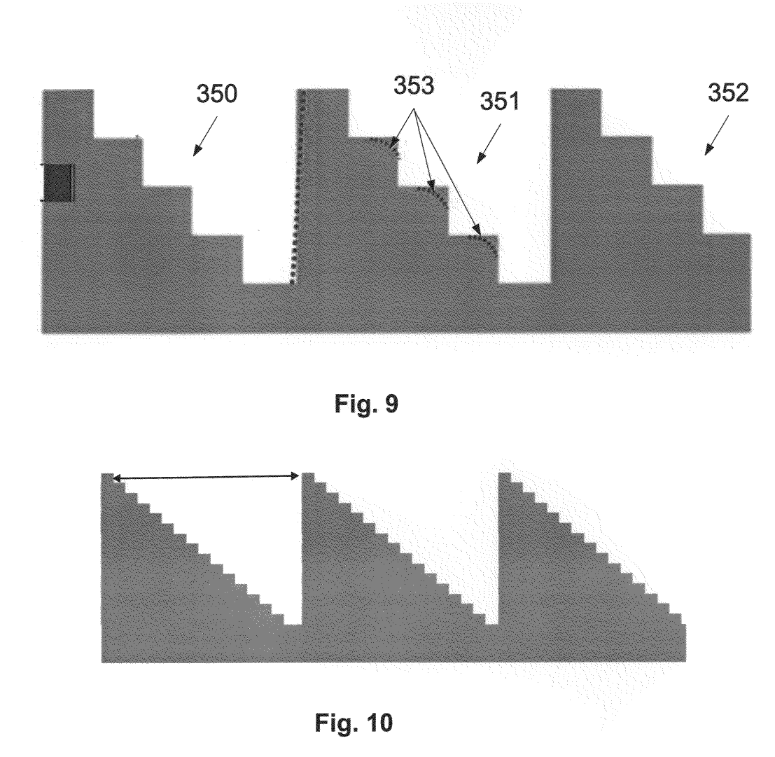

Reference is now made to FIG. 9, which is a schematic illustration of three sequential segments 350, 351, and 352 of a unique profile of the grating grooves, optionally as used in the diffractive optics sub-elements 201, 202, according to one embodiment of the present invention.

As commonly known, diffraction gratings are manufactured either with the use of a ruling engine by burnishing grooves with a diamond stylus or with the use of interference fringes generated at the intersection of two laser beams, see Diffraction Gratings Ruled and Holographic Handbook, published by Jobin Yvon Inc, Edison, N.J. 08820 USA and JobinYvon Div. d'Instruments SA., 1618 Rue du Canal 91160 Longiumeau, France, which is incorporated herein by reference. FIG. 9 depicts a unique profile that allows the diffraction that is depicted in FIGS. 4-5 and described above. The unique profile of the grating grooves is designed to improve significantly the efficiency of the diffraction in a certain diffractive order.

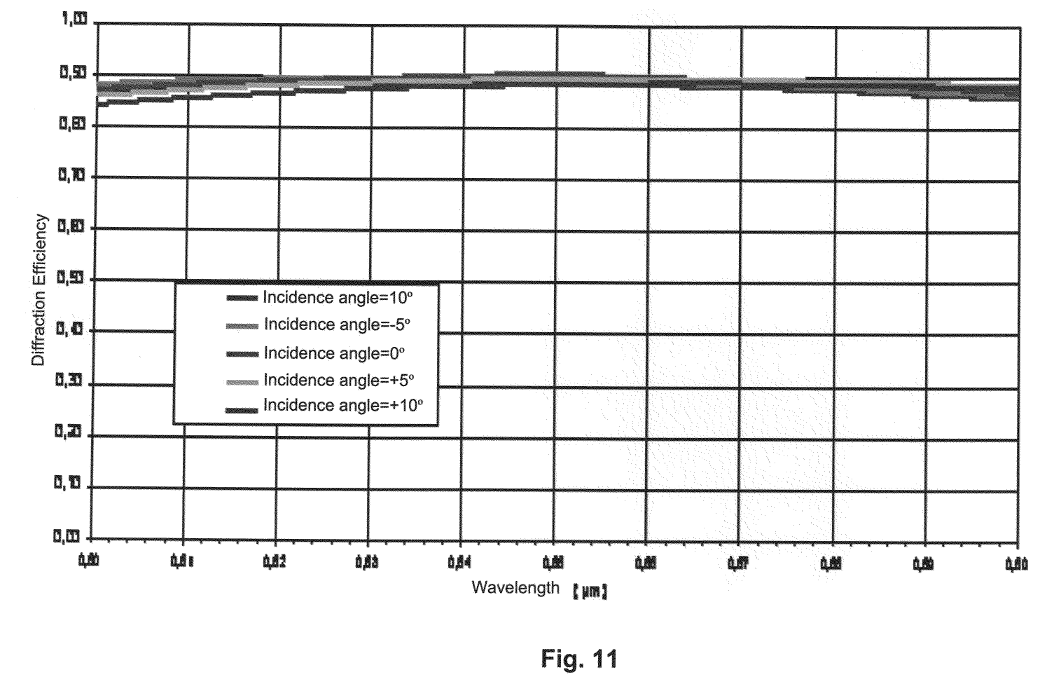

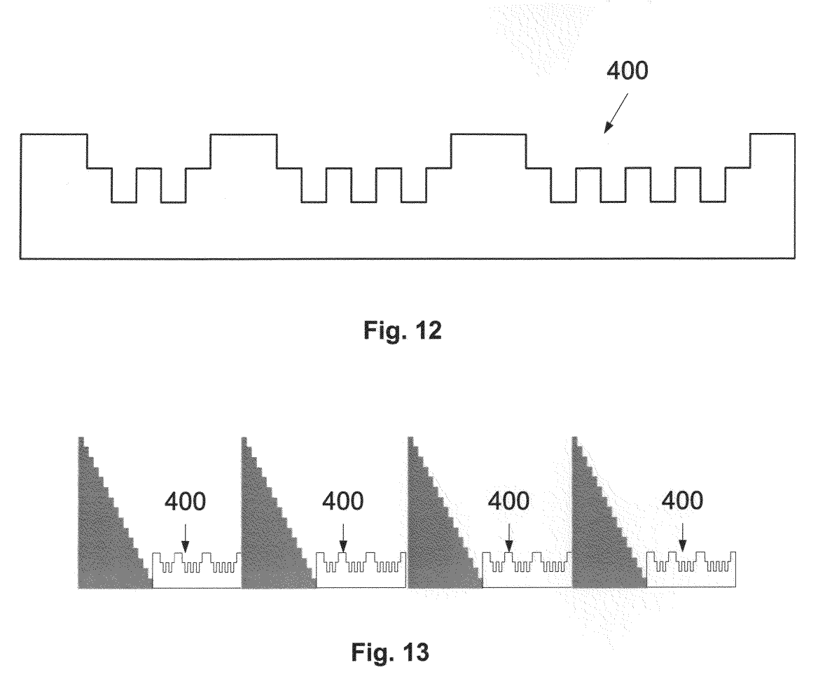

Optionally, each grating groove, for example 350, 351, and 352, comprises a number of steps. Optionally, each one of the steps is rounded, for example as depicted in 353. In order to allow the manufacturing of a grating that can provide outcomes which are similar to the outcomes of the grating that is depicted in FIG. 9, for example by the use of a diamond stylus, a simpler pattern of grooves may be provided, for example as shown at FIG. 10 that depicts a schematic illustration of three segments of an exemplary profile of a grating. In this exemplary profile, each groove includes 15 steps; each diffracts light that is centered on a different wavelength. The 15 steps are designed to achieve at least 80%-90% diffraction efficiency. For example, as depicted in FIG. 11, which is a table depicting the diffraction efficiency of light that impedes the grating in different angles. Reference is now also made to FIG. 12, which is a schematic illustration of a kinoform 400 which is designed to be integrated into a grating, for example as the grating that is used for the first and the second diffractive optics sub-elements 201, 202, according to an embodiment of the present invention.

Optionally, the grating of the second diffractive optics sub-elements 201, 202 is integrated with a kinoform 400 that may be understood as a computer-generated optical element that is designed to diffract light on the phase of an incident wave and to form a single image by wavefront reconstruction. Optionally, the kinoform 400 is designed to correct or to reduce chromatic aberrations, such as axial, longitudinal, lateral, or transverse chromatic aberrations. The correction may be achieved by using various groove frequencies along the grating. The correction depends on the magnitude of the chromatic aberration.

Optionally, a monochromatic kinoform is added in order to correct monochromatic aberrations chromatic. For instance the monochromatic kinoform is used for correcting monochromatic aberrations such as Piston, Tilt, Defocus, Spherical, Coma, Astigmatism, Curvature of field and Image distortion.

Optionally, the chromatic and/or the monochromatic kinoforms are positioned 10 between the aforementioned segments, for example as depicted in FIG. 13, which is a schematic illustration of exemplary three grooves, optionally as depicted in FIG. 10, and three exemplary kinoforms, each optionally as depicted in FIG. 12.

Optionally, the display 102 configures its presentation according to known optical aberrations, such as chromatic and/or monochromatic aberrations, which are 1 5 caused by the diffraction of the diffractive optics element 101. Optionally, the display 102 includes a conversation module that is configured for converting an original image, such as an image of a UI, to an image that is adjusted according to these optical aberrations. The adjusted image is presented on the display 102 and the diffraction of light, which is emitted from this presentation, emulates the original 20 image at the imaging device POV 103.

In such an embodiment, the conversation module may consider known monochromatic aberrations while calculating the adjusted image. For example, emissions of different pixels of the display 102, which are diffracted to a common point at the imaging device POV 103, may be adjusted with different colors, such as 25 blue and red, for emulating an emission of a pixel that has a combined color, such as violet, at that common point. In another embodiment, a pixel, which is positioned in one location in relation to the frame of the adjusted image, for example in coordinates (x, y), is designed to emit light that is diffracted to be presented in another location, for example in coordinates (z, w) where z≠x and/or y≠w, that is respective to the location thereof in the original image.

Optionally, the imaging device 100 is positioned in a handheld device that includes a display for displaying a user interface (UI). The imaging device 100 allows the users of these handheld devices to view the displayed UI from a perceived distance that is different from the actual distance between her eyes and the display. Some handheld devices, such as a mobile phone, a dual-mode phone, or a PDA, are designed to be carried by the observer and to be viewed when they are held by her. In such handheld devices, the distance between the observer and the display is limited to the length of the observer's arm. Thus, positioning the imaging device 100 in front of the display of these handheld devices may provide an enhanced user experience to the observers of these handheld devices. Optionally, the imaging device 100 is embedded into a handheld device.

Such a handheld device with an embedded imaging device, such as 100, may be used for observers which suffer from Hyperopia. In such an embodiment, the imaging device 100 may use the imaging device 100 for improving the perception of the display, as described above. In another example, an observer that suffers from shortsightedness, also known as myopia, may use the imaging device 100 for improving the perception of the display by manipulating the perceived distance thereof to look as if it is less distant than it is really is. Optionally, the imaging device 100 comprises a thin DOE. As described above, the imaging device 100 may use a DOE and not a set of lenses that have a length defined by a certain optical track. In such a manner, the optical design of the imaging device 100 may relatively thin, allowing the mounting thereof in front of one of the aforementioned devices without adding too much to its length. Optionally, the width and the length of the DOE are adjusted according to the width and the length of the display. Optionally, the DOE and the display have the same width and the length. Optionally, the width and length are ˜45×35 mm. Optionally, the depth of the DOE, which may be understood as height, is ˜3 mm.

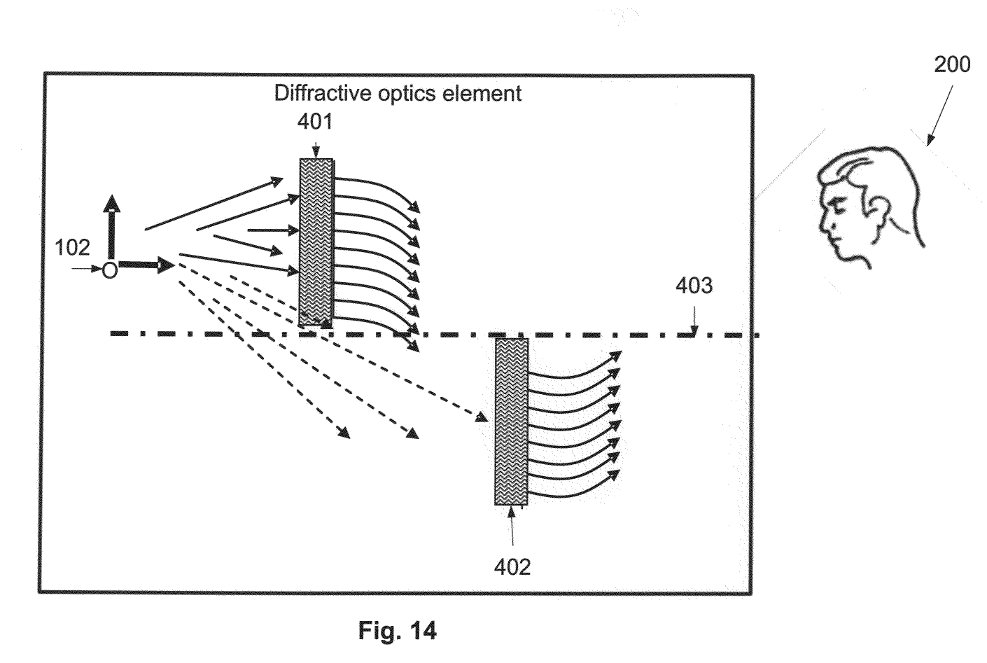

Reference is now made to FIG. 14, which is a schematic illustration of an imaging device 100 having two diffractive optics sub-elements 401, 402 with curved grating, according to a preferred embodiment of the present invention. The display 102 and the observer as depicted in FIG. 2, however in FIG. 14, each one of the two diffractive optics sub-elements 401, 402 has a curved grating.

As depicted in FIG. 2, the DOE 101 may diffract light waves mainly in linear trajectory on a single plane. In such an embodiment, the diffractive optics sub-elements have a grating in which the grooves are straight and substantially parallel to one another.

Optionally, as depicted in FIG. 14 the diffractive optics sub-elements comprises curved grooves. The curvature of the grooves in the grating of the diffractive optics sub-elements 401, 402 converge the light waves which are emitted from the light source 2 at a shorter distance than when the light waves are diffracted in a linear trajectory.

As depicted in FIG. 14, the display 102, which is optionally a source of white-light, is positioned in front of the first diffractive optics sub-element 401 with a spiral diffracting grating. Optionally, the curvatures of the grooves of each diffractive optics sub-element are directed toward a common direction, for example as shown in FIG. 14. The second diffractive optics sub-element 402 collects the light diffracted from the collected by the first diffractive optics sub-element 401 and manipulates it using a second spiral diffracting grating. Optionally, a perpendicular to the diffractive optics sub-elements 401, 402, which may be referred to as a centering line 403, bisects them substantially in the middle. While the first diffractive optics sub-element 401 diffracts the ray lights toward one side of the centering line 403, the second diffractive optics sub-element 402 diffracts the ray lights toward the other side of the centering line 403.

As described above, the imaging device 100 allows the formation of an image of the display at the imaging device POV 103. As described above, light waves emitted from the display 102 impinge the first diffractive optics sub-element 401, optionally perpendicularly to a tangent to the groove profile of the grating thereof. The first diffractive optics sub-element 401 diffracts the light waves towards the second diffractive optics sub-element 402 that diffracts it to the imaging device POV 103, as described above. Optionally, the trajectory of each light wave remains on the same plane of propagation during the first and the second diffractions. In such a manner, a number of emitted light waves pass via a sequence of trajectories, optionally substantially parallel, each directed on a single propagation plane, to create an image of the display 102 at the imaging device POV 103 in the same manner as a linear grating. It should be noted that this description ignores light waves which are emitted toward other direction that is not parallel or substantially parallel to the sequence of trajectories.

Reference is now also made to FIG. 15, which is a flowchart of a method for manipulating a perceived distance of a light source, according to one embodiment of the present invention. First, light waves are received from the display 102. Then, as described above, the light waves are diffracted, optionally by the DOE 101, toward the imaging device POV 103. As described above, the diffraction of the light waves manipulates the perceived distance of the display 102 for the observer 200 at the POV 103 and the perceived distance is different from the actual distance.

It is expected that during the life of this patent many relevant devices and systems will be developed and the scope of the terms herein, particularly of the terms a diffractive optics element, a holographic grating, an image sensor, and an imaging device are intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. An apparatus for manipulating a perceived distance of a display, comprising:
a display having an actual distance from a point of view (POV); and
a diffractive optics element configured for diffracting a plurality of light waves emitted from said display toward said POV, thereby manipulating a perceived distance of said display for an observer at said POV;
wherein said perceived distance is different from said actual distance.

2. The apparatus of claim 1, wherein said display is a source of white light.

3. The apparatus of claim 1, wherein said display is a flat panel display.

4. The apparatus of claim 1, further comprising a correction element configured for correcting optical aberrations of said display.

5. The apparatus of claim 4, wherein said correction element comprises a monochromatic kinoform for correcting monochromatic aberrations of said display.

6. The apparatus of claim 1, wherein said diffractive optics element comprises a graded grating configured for diffracting said plurality of light waves toward said POV.

7. The apparatus of claim 1, wherein said diffractive optics element is configured for diffracting a plurality of light waves while maintaining more than 80% diffraction efficiency.

8. The apparatus of claim 1, wherein said display comprises a user interface display.

9. The apparatus of claim 1, wherein said diffractive optics element is configured for converging light waves of said plurality of light waves onto an optical coincidence at said POV.

10. The apparatus of claim 1, wherein said display is perceived in focus by said observer at said POV.

11. The apparatus of claim 9, wherein said diffractive optics element comprises at least first and second diffractive optics elements, said first diffractive optics element being configured for diffracting light onto said second diffractive optics element, said second diffractive optics element being configured for performing said converging.

12. The apparatus of claim 11, wherein each said first and second diffractive optics elements respectively comprising first and second curved gratings, said first and second curved gratings being configured to diffract said plurality of light waves toward substantially opposite directions.

13. The apparatus of claim 11, wherein said first and second diffractive optics elements respectively have first and second diffraction orders, said first diffraction order being higher than said second diffractive order.

14. The apparatus of claim 1, wherein said perceived distance is longer than from than said actual distance.

15. The apparatus of claim 1, wherein said perceived distance is shorter than said actual distance.

16. The apparatus of claim 1, wherein said diffractive optics element comprising a member of the group consisting of: holographic transmission gratings with linear grooves, holographic transmission gratings with circular grooves, blazed gratings, kinoform gratings, and sinusoidal gratings.

17. The apparatus of claim 1, wherein said display comprises a conversation module for converting an original image to an adjusted image according to optical aberration of said diffractive optics element, said display being configured for presenting said adjusted image.

18. The apparatus of claim 17, wherein said optical aberration comprises a member of a group comprising a monochromatic aberration and a chromatic aberration.

19. The apparatus of claim 17, wherein said original image depicts a user interface display.

20. A handheld device for displaying a user interface, comprising:
a display having an actual distance from a point of view (POV); and
an embedded light manipulation element, positioned substantially in front of said display, configured for manipulating a perceived distance of said display from an observer at said POV;
wherein said perceived distance is different from said actual distance.

21. The handheld of claim 20, wherein said light manipulation element comprises a diffractive optics element configured for manipulating said perceived distance by diffracting an image of said display toward said POV.

22. The handheld of claim 20, further comprising a user interface module configured for displaying a user interface on said display embedded light manipulation being configured for manipulating a perceived distance of said user interface from an observer at said POV.

23. The handheld of claim 20, wherein said handheld device is a cellular phone.

24. The handheld of claim 20, wherein the thickness of said embedded light manipulation element is less than 3 mm.

25. A method for manipulating a perceived distance of a display, comprising:
receiving a plurality of light rays from a display having an actual distance from a point of view (POV); and
diffracting said plurality of light rays toward said POV;
wherein for an observer at said POV a perceived distance of said display is manipulated by said diffraction, said perceived distance being different from said actual distance.

26. The method of claim 25, wherein said diffracting comprises focusing an image of said display at said POV.

27. The method of claim 25, wherein said diffracting comprises converging said plurality of light waves onto an optical coincidence at said POV.

28. The method of claim 25, wherein said diffracting comprises expecting the trajectory of said plurality of light waves.

29. The method of claim 25, further comprising displaying a user interface on said display before said receiving, said plurality of light waves being emitted from said displayed user interface.

30. The method of claim 25, wherein for said observer said display is perceived as more distant than said actual distance.

31. The method of claim 25, wherein for said observer said display is perceived as less distant than said actual distance.
